(19) United States
(12) Patent Application Publication
(10) Pub. No.: US 2015/0339024 A1
(43) Pub. Date: Nov. 26, 2015

(54) Device and Method For Transmitting Information

(71) Applicant: Aniya's Production Company, Los Angeles, CA (US)

(72) Inventor: Damon Wayans, Los Angeles, CA (US)

(21) Appl. No.: 14/546,726

(22) Filed: Nov. 18, 2014

Related U.S. Application Data
(60) Provisional application No. 62/001,213, filed on May 21, 2014.

(51) Int. Cl. G06F 3/0488; G06F 3/041

(52) U.S. Cl. CPC G06F 3/0488; G06F 3/0412; G06F 2203/04808

(57) ABSTRACT

A device and method are presently disclosed. The computer implemented method, includes an electronic device with a touch-sensitive display, displaying a representation of a human being on the touch-sensitive display, while displaying the representation of the human being, detecting user's finger contact with the touch-sensitive display, and in response to detecting the user's finger contact, displaying a video in a head of the representation of the human being.

### CROSS REFERENCE TO RELATED APPLICATIONS

This application claims the benefit of U.S. Provisional Application No. 62/001,213, filed on May 21, 2014, which is incorporated herein by reference in its entirety.

### FIELD

The present invention relates to electronic devices. More particularly, the present invention relates to electronic devices configured to transmit information.

### BACKGROUND

As known in the art, users are able to transmit information using emails and/or text messages. However, the way this information looks static and boring.

Embodiments disclosed in the present disclosure overcome the limitations of the prior art.

### BRIEF DESCRIPTION OF THE FIGURES

FIG. 1 depicts a block diagram of a portable device as known in the art.

FIG. 2 depicts a user interface in accordance with some embodiments presently disclosed.

FIG. 3 depicts another user interface in accordance with some embodiments presently disclosed.

FIG. 4 depicts another user interface in accordance with some embodiments presently disclosed.

FIG. 5 depicts another user interface in accordance with some embodiments presently disclosed.

FIG. 6 depicts another user interface in accordance with some embodiments presently disclosed.

FIG. 7 depicts another user interface in accordance with some embodiments presently disclosed.

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

According to one aspect, a computer implemented method is presently disclosed. The method comprising an electronic device with a touch-sensitive display, displaying a representation of a human being on the touch-sensitive display, while displaying the representation of the human being, detecting user's finger contact with the touch-sensitive display, and in response to detecting the user's finger contact, displaying a video in a head of the representation of the human being.

According to another aspect, a computer implemented method is disclosed. The method comprising: an electronic device with a touch-sensitive display, displaying a representation of a human being on the touch-sensitive display, while displaying the representation of the human being, detecting user's finger contact with the touch-sensitive display, and in response to detecting the user's finger contact, displaying an image in a head of the representation of the human being.

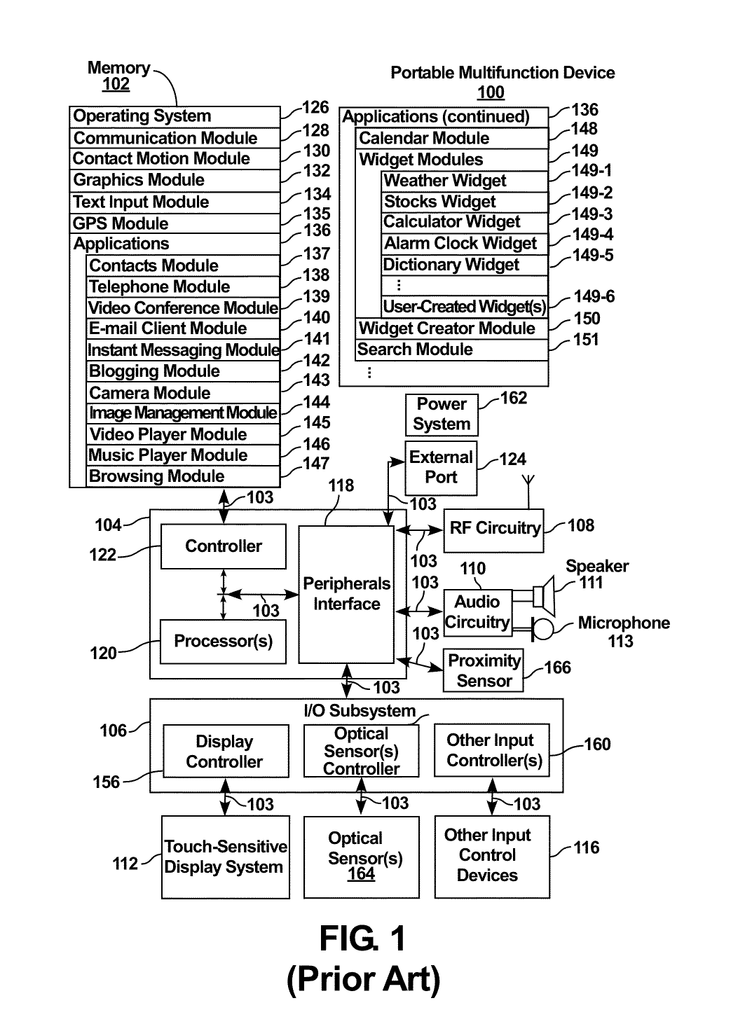

An electronic device 100 as known in the art is shown in FIG. 1. The device 100 may comprise a memory 102 (which may comprise one or more computer readable storage mediums), an input/output (I/O) subsystem 106, a memory controller 122, one or more processing units (CPU's) 120, a peripherals interface 118, an audio circuitry 110, a speaker 111, a microphone 113, and one or more optical sensors 164 in accordance with some embodiments. These components may communicate over one or more communication buses or signal lines 103.

The memory 102 may comprise high-speed random access memory and/or non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122.

The peripherals interface 118 couples the input and output peripherals of the device 100 to the CPU 120 and memory 102. The one or more processors 120 run or execute various software programs and/or sets of instructions stored in memory 102 to perform various functions for the device 100 and to process data. The peripherals interface 118, the CPU 120, and the memory controller 122 may be implemented on a single chip, such as a chip 104. In some other embodiments, they may be implemented on separate chips.

The audio circuitry 110, the speaker 111, and the microphone 113 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 by the peripherals interface 118. The audio circuitry 110 may also comprise a headset/speaker jack (not shown). The headset jack provides an interface between the audio circuitry 110 and removable audio input/output peripherals, such as speaker, output-only headphones and/or a headset with both output (e.g., a headphone for one or both ears) and input (e.g., a microphone).

The device 100 may further comprise a touch-sensitive display 112, other input or control devices 116, radio frequency (RF) circuitry 108, and/or an external port 124 in accordance with some embodiments. These components may also communicate over one or more communication buses or signal lines 103.

As known in the art, the device 100 as shown in FIG. 1 may comprise more or fewer components than shown, may combine two or more components, or a may have a different configuration or arrangement of the components. The various components shown in FIG. 1 may be implemented in hardware, software or a combination of both hardware and software, including one or more signal processing and/or application specific integrated circuits.

In one embodiment, the device 100 is a cellular phone. In another embodiment, the device 100 is a video camera. In another embodiment, the device 100 is a camera. In another embodiment, the device 100 is a video camera. In another embodiment, the device 100 is a computer. In another embodiment, the device 100 is a portable computer. In another embodiment, the device 100 is a tablet.

The device 100 may also comprise a radio frequency (RF) circuitry 108. The RF circuitry 108 may be configured to receive and transmit RF signals, also called electromagnetic signals. The RF circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

The I/O subsystem 106 couples input/output peripherals on the device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include one or more physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons (not shown) may include an up/down button for volume control of the speaker 111 and/or the microphone 113.

The touch-sensitive display 112 is sometimes called a “touch screen” for convenience, and may also be known as or called a touch-sensitive display system. In one embodiment, the touch-sensitive touch screen 112 provides an input interface and an output interface between the device 100 and a user. The touch screen 112 is configured to implement virtual or soft buttons and one or more soft keyboards. The display controller 156 receives and/or sends electrical signals from/to the touch screen 112. The touch screen 112 displays visual output to the user. The visual output may include graphics, text, icons, video, and any combination thereof (collectively termed “graphics”). In some embodiments, some or all of the visual output may correspond to user-interface objects, further details of which are described below.

The touch screen 112 has a touch-sensitive surface, sensor or set of sensors that accepts input from the user based on haptic and/or tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects (e.g., one or more soft keys, icons, web pages or images) that are displayed on the touch screen. In one embodiment, a point of contact between a touch screen 112 and the user corresponds to a finger of the user.

The touch screen 112 may use LCD (liquid crystal display) technology, or LPD (light emitting polymer display) technology, although other display technologies may be used in other embodiments. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112.

A touch-sensitive display in some embodiments of the touch screen 112 may be analogous to the multi-touch sensitive tablets described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, a touch screen 112 displays visual output from the portable device 100, whereas touch sensitive tablets do not provide visual output.

A touch-sensitive display in some embodiments of the touch screen 112 may be as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

The touch screen 112 may have a resolution of 100 dpi. to 160 dpi. The user may make contact with the touch screen 112 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

In addition to the touch screen 112, the device 100 may comprise a touchpad (not shown) for activating or deactivating particular functions. The touchpad is a touch-sensitive area of the device that, unlike the touch screen, does not display visual output. The touchpad may be a touch-sensitive surface that is separate from the touch screen 112 or an extension of the touch-sensitive surface formed by the touch screen.

The device 100 may also comprise a physical or virtual click wheel (not show) as an input control device 116. A user may navigate among and interact with one or more graphical objects (henceforth referred to as icons) displayed in the touch screen 112 by rotating the click wheel or by moving a point of contact with the click wheel (e.g., where the amount of movement of the point of contact is measured by its angular displacement with respect to a center point of the click wheel). The click wheel may also be used to select one or more of the displayed icons. For example, the user may press down on at least a portion of the click wheel or an associated button. User commands and navigation commands provided by the user via the click wheel may be processed by an input controller 160 as well as one or more of the modules and/or sets of instructions in memory 102. For a virtual click wheel, the click wheel and click wheel controller may be part of the touch screen 112 and the display controller 156, respectively. For a virtual click wheel, the click wheel may be either an opaque or semitransparent object that appears and disappears on the touch screen display in response to user interaction with the device. In some embodiments, a virtual click wheel is displayed on the touch screen of a portable multifunction device and operated by user contact with the touch screen.

The device 100 may further comprise a power system 162 for powering the various components. The power system 162 may comprise a power management system, one or more power sources (e.g., battery, alternating current (AC)), a recharging system, a power failure detection circuit, a power converter or inverter, a power status indicator (e.g., a light-emitting diode (LED)) and/or any other components associated with the generation, management and distribution of power in portable devices.

The optical sensor 164 of the device 100 may be electrically coupled with an optical sensor controller 158 in I/O subsystem 106. The optical sensor 164 may comprise charge-coupled device (CCD) or complementary metal-oxide semiconductor (CMOS) phototransistors. The optical sensor 164 receives light from the environment, projected through one or more lens, and converts the light to data representing an image. In conjunction with an imaging module 143 (also called a camera module), the optical sensor 164 may capture visual media (i.e. still images or video). In some embodiments, the optical sensor 164 may be located on the back of the device 100, opposite the touch screen display 112 on the front of the device 100, so that the touch screen display 112 may be used as a viewfinder for either still and/or video image acquisition. In some embodiments, the optical sensor 164 may be located on the front of the device 100 to capture image(s) of the user. In some embodiments, one optical sensor 164 may be located on the back of the device 100 and another optical sensor 164 may be located on the front of the device 100. In some embodiments, the position of the optical sensor 164 may be changed by the user (e.g., by rotating the lens and the sensor in the device housing) so that a single optical sensor 164 may be used along with the touch screen display to capture still and/or video image.

The device 100 may also comprise one or more accelerometers 168. FIG. 1 shows an accelerometer 168 coupled to the peripherals interface 118. Alternately, the accelerometer 168 may be coupled to an input controller 160 in the I/O subsystem 106. The accelerometer 168 may perform as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are which are incorporated herein by reference in their entirety. Information may be displayed on the touch screen display 112 in a portrait view or a landscape view based on an analysis of data received from the one or more accelerometers 168.

As known in the art, the memory 102 may be configured to store one or more software components as described below.

The memory 102 may be configured to store an operating system 126. The operating system 126 (e.g., Darwin, RTXC, LINUX, UNIX, OS X, WINDOWS, or an embedded operating system such as VxWorks) comprises various software components and/or drivers for controlling and managing general system tasks (e.g., memory management, storage device control, power management, etc.) and facilitates communication between various hardware and software components.

The memory 102 may also be configured to store a communication module 128. The communication module 128 facilitates communication with other devices over one or more external ports 124 and also includes various software components for handling data received by the RF circuitry 108 and/or the external port 124. In one embodiment, the external port 124 (e.g., Universal Serial Bus (USB), FIREWIRE, etc.) is configured for coupling directly to other devices or indirectly over a network (e.g., the Internet, wireless LAN, etc.).

The memory 102 may be configured to store a contact/motion module 130. The contact/motion module 130 is configured to detect contact with the touch screen 112 (in conjunction with the display controller 156) and other touch sensitive devices (e.g., a touchpad or physical click wheel). The contact/motion module 130 includes various software components for performing various operations related to detection of contact, such as determining if contact has occurred, determining if there is movement of the contact and tracking the movement across the touch screen 112, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). The contact/motion module 130 and the display controller 156 may also detect contact on a touchpad. The contact/motion module 130 and the controller 160 may further detect contact on a click wheel.

The memory 102 may be configured to store a graphics module 132. The graphics module 132 comprises various known software components for rendering and displaying graphics on the touch screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like.

The memory 102 may also be configured to store a text input module 134. The text input module 134, which may be a component of graphics module 132, provides soft keyboards for entering text in various applications that need text input.

The memory 102 may be configured to store a GPS module 135. The GPS module 135 determines the location of the device and provides this information for use in various applications (e.g., to camera module 143 as picture/video metadata).

The memory 102 may be configured to store applications 136. The applications 136 may comprise one or more of the following modules (or sets of instructions), or a subset or superset thereof: a camera module 143 for still and/or video images; an image management module 144; a video player module 145; a music player module 146; and/or online video module 155.

As known in the art, applications 136 may comprise additional modules (or sets of instructions). For example, other applications 136 that may be stored in memory 102 may include one or more of the following: a contacts module 137 (sometimes called an address book or contact list); a telephone module 138; a video conferencing module 139; an e-mail client module 140; an instant messaging (IM) module 141; a blogging module 142; a browser module 147; a calendar module 148; widget modules 149, which may include weather widget 149-1, stocks widget 149-2, calculator widget 149-3, alarm clock widget 149-4, dictionary widget 149-5, and other widgets obtained by the user, as well as user-created widgets 149-6; widget creator module 150 for making user-created widgets 149-6; search module 151; notes module 153; map module 154; word processing applications; JAVA-enabled applications; encryption; digital rights management; voice recognition; and/or voice replication.

As known in the art, the camera module 143 (in conjunction with, for example, touch screen 112, display controller 156, optical sensor(s) 164, optical sensor controller 158, contact module 130, graphics module 132, and image management module 144) may be configured to capture still images or video (including a video stream) and store them into memory 102, modify characteristics of a still image or video, or delete a still image or video from memory 102.

As known in the art, the image management module 144 (in conjunction with, for example, touch screen 112, display controller 156, contact module 130, graphics module 132, text input module 134, and camera module 143) may be configured to arrange, modify or otherwise manipulate, label, delete, present (e.g., in a digital slide show or album), and store still and/or video images.

As known in the art, the video player module 145 (in conjunction with, for example, touch screen 112, display controller 156, contact module 130, graphics module 132, audio circuitry 110, and speaker 111) may be configured to display, present or otherwise play back videos (e.g., on the touch screen 112 or on an external, connected display via external port 124).

As known in the art, the online video module 155 (in conjunction with, for example, touch screen 112, display system controller 156, contact module 130, graphics module 132, audio circuitry 110, speaker 111, RF circuitry 108,) may be configured to allow the user to access, browse, receive (e.g., by streaming and/or download), play back (e.g., on the touch screen 112 or on an external, connected display via external port 124), upload and/or otherwise manage online videos in one or more file formats, such as, for example, H.264.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. For example, video player module 145 may be combined with music player module 146 into a single module. The memory 102 may store a subset of the modules and data structures identified above. Furthermore, memory 102 may store additional modules and data structures not described above.

The device 100 may be configured so as to allow operation of a predefined set of functions on the device be performed exclusively through a touch screen 112 and/or a touchpad. By using a touch screen and/or a touchpad as the primary input/control device for operation of the device 100, the number of physical input/control devices (such as push buttons, dials, and the like) on the device 100 may be reduced.

The predefined set of functions that may be performed exclusively through a touch screen and/or a touchpad may include navigation between user interfaces. In some embodiments, the touchpad, when touched by the user, navigates the device 100 to a main, home, or root menu from any user interface that may be displayed on the device 100.

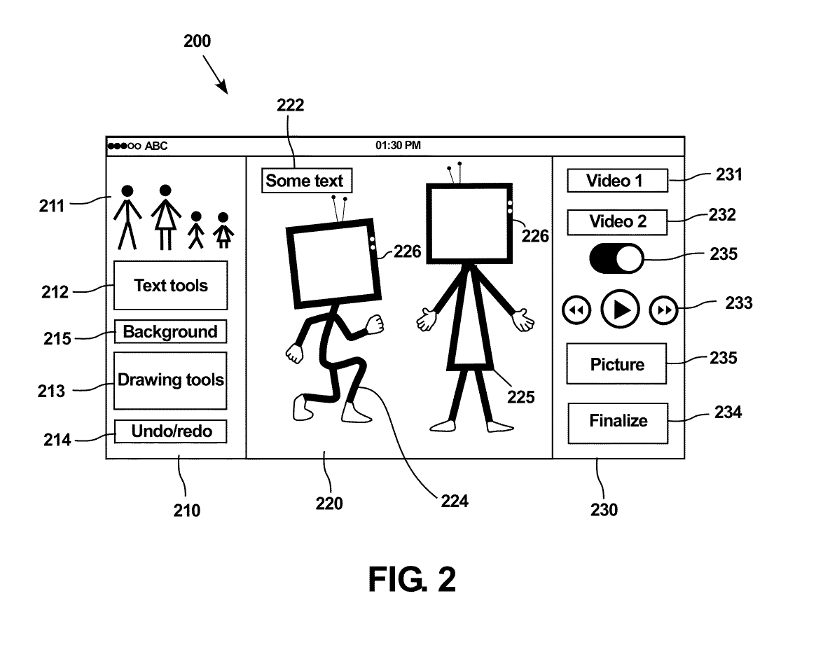

FIG. 2 illustrates user interfaces for an application that may be implemented, for example, in the device 100 or other electronic devices in accordance with some embodiments presently disclosed. In some embodiments presently disclosed, a computer-implemented method is performed at an electronic device (e.g., 100) with a touch screen display 112.

In some embodiments, in response to a series of gestures (e.g. finger taps) by a user, the device 100 displays a creation screen 200 with one or more sections 210, 220 and/or 230 as shown in FIG. 2. In some embodiments, section 210 displays one or more icons/tools (i.e. virtual buttons) 211, 212, 213, 214 and/or 215 as shown in FIG. 2. In some embodiments, the icons 211 include computer generated representation of a man, woman, boy and/or girl that can be dragged by the user to the section 220. In some embodiments, the icons 211 include computer generated representation of a man, woman, boy and/or girl that can selected by the user to appear in the section 220. In some embodiments, the computer generated representation of a man, woman, boy and/or girl are shown as stick figures as shown in FIG. 2.

In some embodiments, in response to a series of gestures (e.g. finger taps) by the user, the device 100 allows the user to select the icon 212 and drag one or more text boxes 222 to the section 220 as shown in FIG. 2. In some embodiments, in response to a series of gestures (e.g. finger taps) by the user, the device 100 allows the user to type one or more letters in the text box 222.

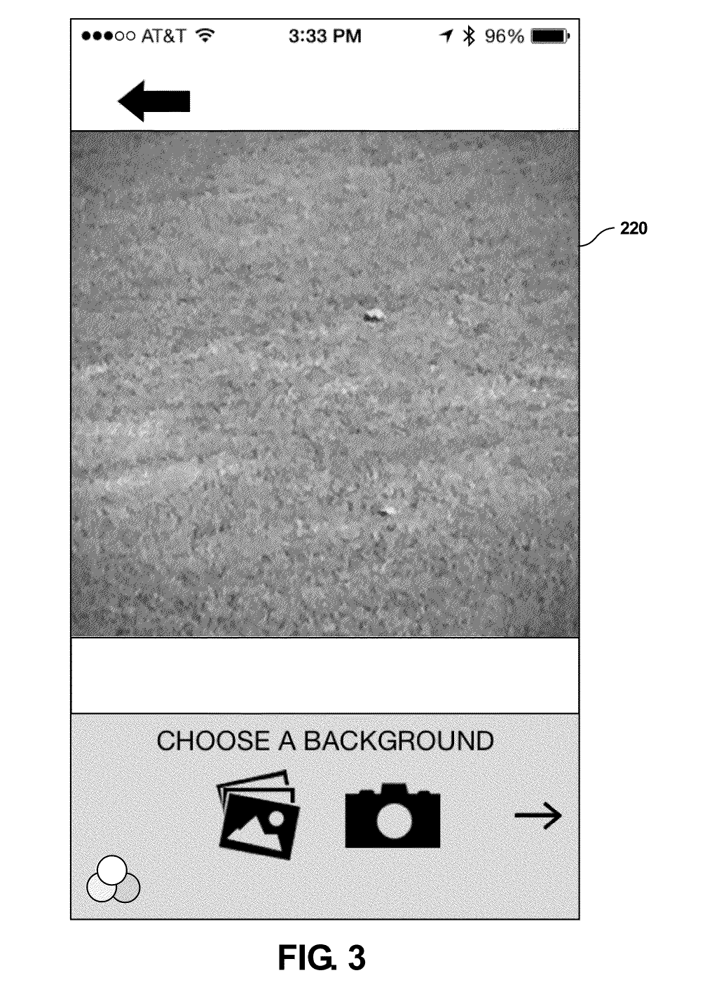

In some embodiments, in response to a series of gestures (e.g. finger taps) by the user, the icon 215 allows the user to select one or more images to be displayed as background in the section 220 as shown in FIG. 3. In some embodiments, the background images are stored in the memory 102 of the device 100. In some embodiments, the background images are stored on an external storage device and/or server. In some embodiments, in response to a series of gestures (e.g. finger taps) by the user, selecting the icon 215 allows the users to take a new photograph using, for example, optical sensor 164 and use it as background.

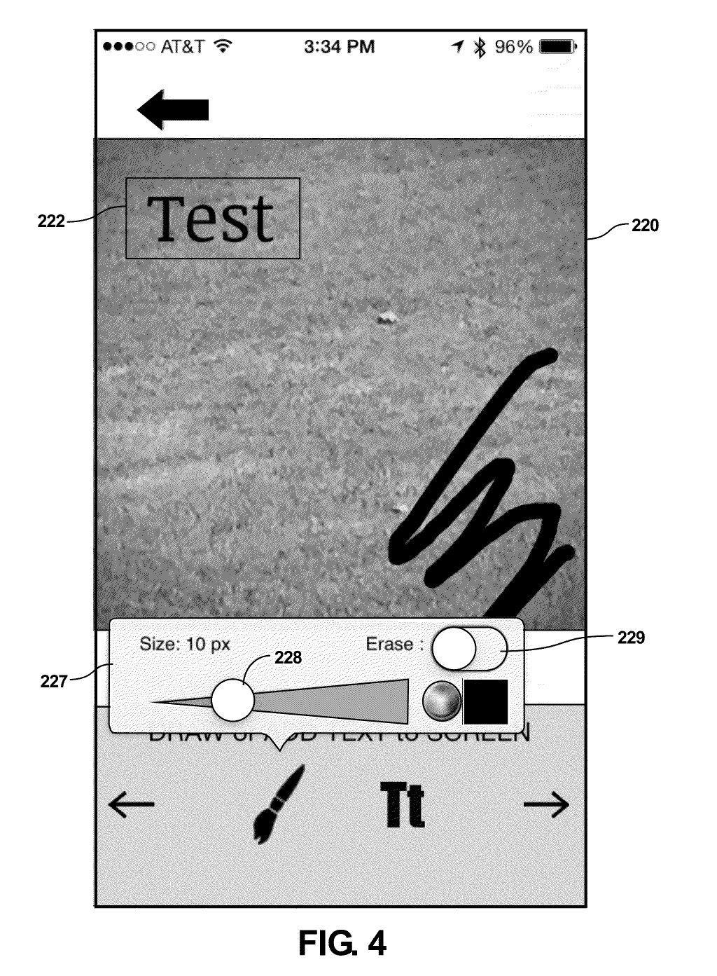

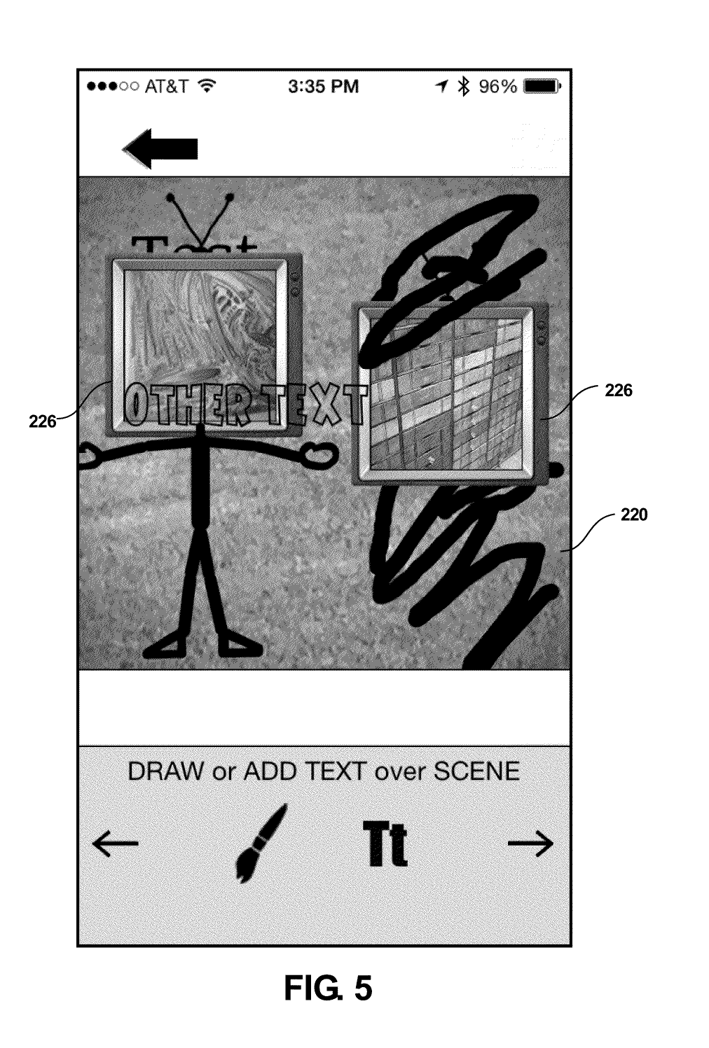

In some embodiments, in response to a series of gestures (e.g. finger taps) by the user, the icon 213 present the user with one or more drawing tools 227 to allow the user to draw in the section 220 as shown in FIG. 4. In some embodiments, the one or more drawing tools 227 allow the user to paint with their finger (shown in FIG. 4) in the section 220 and provide adjustable finger width size using tool 228. In some embodiments, in response to a series of gestures (e.g. finger taps) by the user, the one or more drawing tools 227 allow the user to specify whether to draw in front of behind the computer generated representation of a man, woman, boy and/or girl as shown in FIG. 5. In some embodiments, in response to a series of gestures (e.g. finger taps) by the user, the one or more drawing tools 227 include an eraser 229 to remove at least a portion of drawing. In some embodiments, the one or more drawing tools 227 include one or more fonts.

In some embodiments, in response to a series of gestures (e.g. finger taps) by the user, the icon 214 allows the user to undo/redo previously made changes.

In some embodiments, in response to a series of gestures (e.g. finger taps) by the user, the section 220 provides a canvas area wherein the user can add one or more computer generated representation of a man, woman, boy and/or girl 224, 225, one or more text boxes 222, and one or more drawings. In some embodiments, the head 226 of the one or more computer generated representation of a man, woman, boy and/or girl 224 looks like a television and/or computer monitor. In some embodiments, the heads 226 that look like television and/or computer monitor are provided without the one or more computer generated representation of a man, woman, boy and/or girl 224, 225. In some embodiments, in response to a series of gestures (e.g. finger taps) by the user, the device 100 allows the user to manipulate (i.e. move) the limbs, neck, wrists, angle and/or any other parts of the computer generated representation of a man, woman, boy and/or girl 224. In some embodiments, in response to a series of gestures (e.g. finger taps) by the user, the device 100 allows the user to move (i.e. change) position of the computer generated representation of a man, woman, boy and/or girl 224. In some embodiments, in response to a series of gestures (e.g. finger taps) by the user, the device 100 allows the user to tap the hands of the computer generated representation of a man, woman, boy and/or girl 224 to switch between open/close hands.

In some embodiments, the head 226 looks like an object that is not human head. In some embodiments, in response to a series of gestures (e.g. finger taps) by the user, the device 100 allows the user to select the head 226 that looks like an outline of a heart, an outline of an automobile, an outline of a geometrical shape (square, rectangle, triangle or any other geometrical shapes), an outline of an animal head, an outline of a building (i.e. structure), an outline of an electronic device (radio, blender, or any other device used by people in their daily lives).

In some embodiments, in response to a series of gestures (e.g. finger taps) by the user, the dimensions (i.e. size) of the head 226 can be adjusted to be bigger and/or smaller.

In some embodiments, representations of the man, woman, boy and/or girl 224, 225 are not computer generated. In some embodiments, representations of the man, woman, boy and/or girl 224, 225 are selected from a one or more pictures of peoples' bodies. For example, in some embodiments, the device 100 may allow the user to select from one or more pictures a picture depicting a body of a man, woman, boy and/or girl. In some embodiments, representations of the man, woman, boy and/or girl 224, 225 are drawn by the user in response to a series of gestures (e.g. finger taps) by the user.

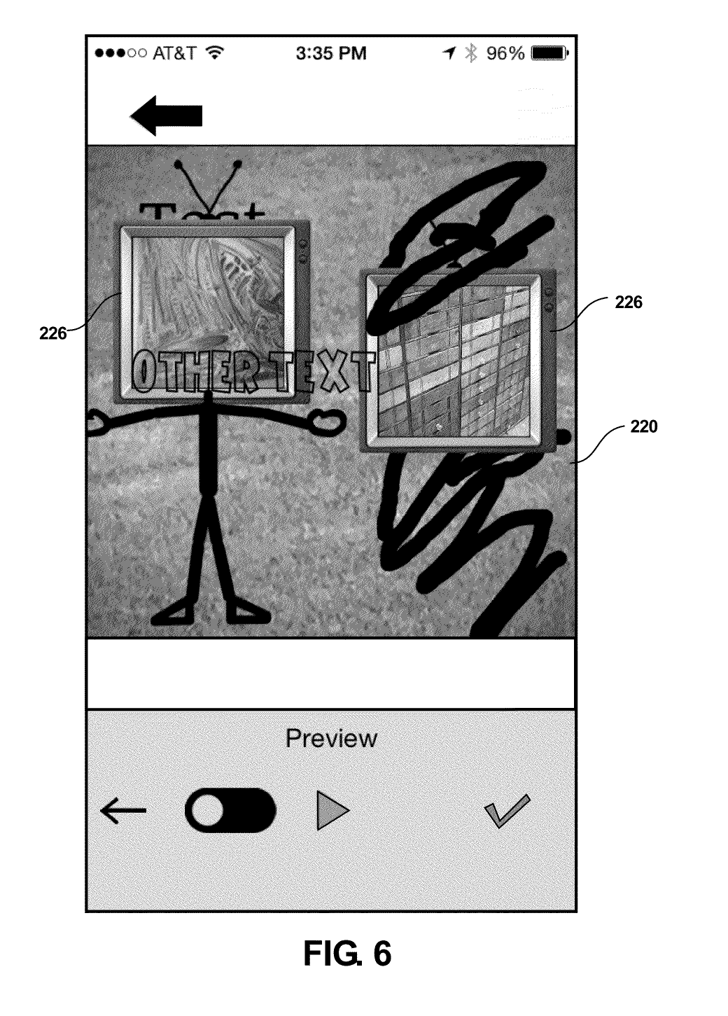

In some embodiments, in response to a series of gestures (e.g. finger taps) by the user, the device 100 allows the user to use the drawing tool 213 to draw representation of a man, woman, boy and/or girl as shown in FIGS. 5-6.

In some embodiments, in response to a series of gestures (e.g. finger taps) by the user, the section 230 displays one or more icons/tools (i.e. virtual buttons) 231, 232, 233, 234 and/or 235 as shown in FIG. 2. In some embodiments, in response to a series of gestures (e.g. finger taps) by the user, the icon 231 and/or 232 allows the user to select an external video or record a video to be shown in the head 226. In some embodiments, the external video is trimmed to a predetermined time. In some embodiments, the predetermined time is 5 seconds. In some embodiments, the length of the recorded video is predetermined. In some embodiments, the predetermined length of the recorded video is 5 seconds.

In some embodiments, the external video and/or recorded video are cropped to fit the aspect ratio of the heads 226. In some embodiments, the section 230 provides one or more icons (not shown) to allow the user to add video filters such as black/white, sepia and/or basic color filters such as Brannon/Lord Kelvin/etc.

In some embodiments, in response to a series of gestures (e.g. finger taps) by the user, the icons 233 allows the user to preview videos to be displayed in the head 226. In some embodiments, in response to a series of gestures (e.g. finger taps) by the user, the switch 235 allows the user to choose which video is to be played first.

In some embodiments, in response to a series of gestures (e.g. finger taps) by the user, the icon 234 allows the user to store the video(s) and the computer generated representation of a man, woman, boy and/or girl 224 and/or 225 to be watched later or to be shared with friends through social network(s), text message, and/or email. In some embodiments, the video(s) are stored as drafts to be modified at another time or to create variations.

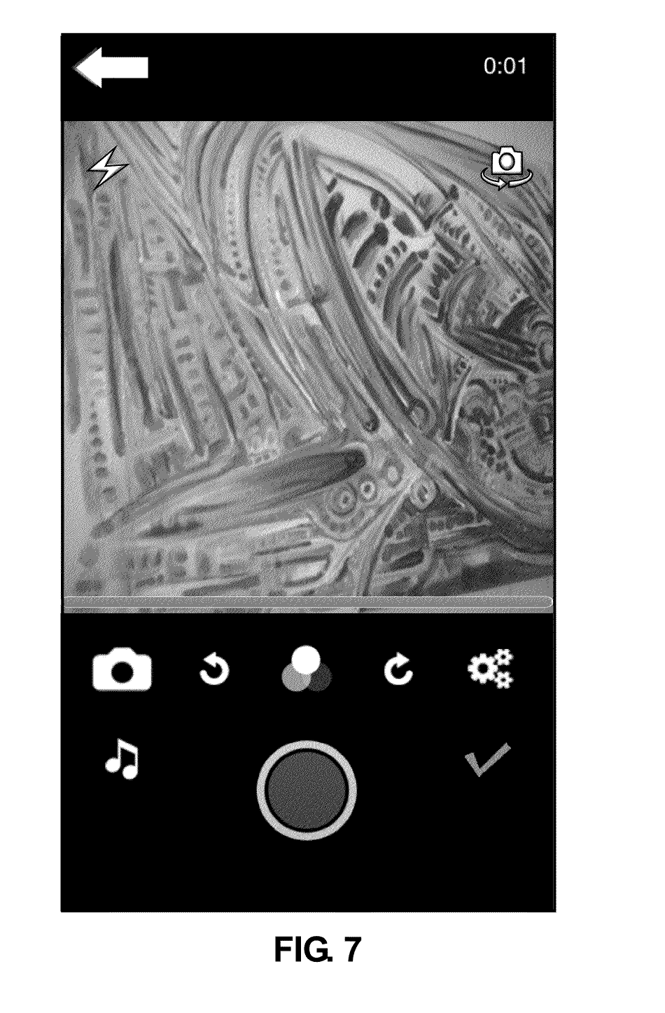

In some embodiments, in response to a series of gestures (e.g. finger taps) by the user, the icon 235 allows the user to select a stored image or take a new photograph (shown in FIG. 7) to be displayed in the heads 226. In some embodiments, the stored images are stored in the memory 102 of the device 100. In some embodiments, the stored images are stored on an external storage and/or server. In some embodiments, selecting the icon 235 allows the users to take a new photograph using, for example, optical sensor 164 and display it in the heads 226.

In some embodiments, in response to a series of gestures (e.g. finger taps) by the user, the device 100 allows the user include audio to be played through the head 226.

In some embodiments, the screen 200 comprises a time feature (not shown) to allow the video to be viewed for a predetermined amount of time.

In some embodiments, the screen 200 comprises a list icon (not shown) to allow the user to view previously saved video(s) and/or drafts of video(s).

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . . ”

What is claimed is:

1. A computer implemented method, comprising:
an electronic device with a touch-sensitive display,
displaying a representation of a human being on the touch-sensitive display;
while displaying the representation of the human being, detecting user's finger contact with the touch-sensitive display; and
in response to detecting the user's finger contact, displaying a video in a head of the representation of the human being.

2. The method of claim 1, wherein the head is shaped as a television set.

3. The method of claim 1, further comprising:
allowing the user to reposition a portion of the representation of the human being.

4. The method of claim 1, further comprising:
allowing the user to adjust the dimensions of the head.

5. The method of claim 1, wherein outline of the head does not look like a human head.

6. A computer implemented method, comprising:
an electronic device with a touch-sensitive display,
displaying a representation of a human being on the touch-sensitive display;
while displaying the representation of the human being, detecting user's finger contact with the touch-sensitive display; and
in response to detecting the user's finger contact, displaying an image in a head of the representation of the human being.

7. The method of claim 6, wherein the head is shaped as a television set.

8. The method of claim 1, further comprising allowing the user to reposition a portion of the representation of the human being.

9. The method of claim 6, further comprising:
allowing the user to adjust the dimensions of the head.

10. The method of claim 6, wherein outline of the head does not look like a human head.
